(19) United States
(12) Patent Application Publication
(10) Pub. No.: US 2017/0162293 A1
(43) Pub. Date: Jun. 8, 2017

(54) WIRE HARNESS

(71) Applicant: SUMITOMO WIRING SYSTEMS, LTD., Mie (JP)

(72) Inventors: Masataka WAKABAYASHI, Mie (JP); Masanori BANDO, Mie (JP)

(73) Assignee: SUMITOMO WIRING SYSTEMS, LTD., Mie (JP)

(21) Appl. No.: 15/354,300

(22) Filed: Nov. 17, 2016

(30) Foreign Application Priority Data
Dec. 7, 2015 (JP) 2015-238616

(51) Int. Cl. H01B 7/00; H01B 3/30; H02G 3/04

(52) U.S. Cl. CPC H01B 7/0045; H02G 3/0462; H01B 3/30

(57) ABSTRACT

The present invention aims to provide a wire harness in which: a tube-shaped space is formed by an exterior member, and a set of electrical wires are housed therein without being tied together; the set of electrical wires is prevented from protruding from an end edge of the exterior member on a winding start side even if the length of the exterior member by which the set of electrical wires is covered is large; and the wind overlapping portion of the exterior member on one end side is larger than that on the other end side so that a stably tied state of the electrical wires is satisfactorily ensured and the tying force on one end side is efficiently transmitted to the other end side. The wire harness includes: a set of electrical wires; and an exterior member that is wound around the set of electrical wires.

### CROSS-REFERENCE TO RELATED APPLICATIONS

The present application claims priority under 35 U.S.C. §119 of Japanese Application No. 2015-238616, filed on Dec. 7, 2015, the disclosure of which is expressly incorporated by reference herein in its entirety.

### TECHNICAL FIELD

The present invention relates to a wire harness in which an exterior member is wound around a set of electrical wires in a cylindrical shape.

### BACKGROUND ART

FIG. 4 is a perspective view showing a wire harness disclosed in JP 3179032U. A wire harness 10 includes a set of electrical wires 11 and an exterior member 12 that is wound around the set of electrical wires 11 in a cylindrical shape. This exterior member 12 has an elongated rectangular shape in planar laid-out view, and has been bent into a cylindrical shape such that an end edge 12a on the winding start side and an end edge 12b on the winding end side overlap each other by approximately half a wrap. The set of electrical wires 11 loosely passes through the exterior member 12.

Although there is no public information in the form of a patent document, there is a known wire harness in which, as with the wire harness disclosed in JP 3179032U, a cylindrical exterior member that is formed by bending a woven cloth of PET and in which an end edge on the winding start side and an end edge on the winding end side overlap each other, is wound around a set of electrical wires in a cylindrical shape. One end of the wire harness is fixed, and the other end is used as a projecting end.

JP 3179032U is an example of related art.

### SUMMARY OF THE INVENTION

### Technical Problem

However, if the wire harness 10 disclosed in JP 3179032U is used, it is necessary to open the exterior member 12 that is wound in a cylindrical shape, in order to house the set of electrical wires 11 in the exterior member 12. It is troublesome to house the set of electrical wires 11 that have not been tied together in advance, and it is likely that a gap will be formed between the end edge 12a on the winding start side and the end edge 12b on the winding end side. There is the risk of some of the electrical wires protruding from the gap, and in order to avoid such a situation, it is necessary to tie the set of electrical wires 11 together in advance. This is problematic.

Also, in the case of the above-described wire harness formed by bending a woven cloth, if the set of electrical wires is long, there is the risk of a gap being formed between an overlapping portion of the end edge on the winding start side and an overlapping portion of the end edge on the winding end side, and there is the risk of some of the electrical wires protruding from the gap between the overlapping portions of the exterior member. Therefore, it is necessary to tie the set of electrical wires together in advance. This is problematic.

The present invention has been made to solve the above-described problems, and aims to provide a wire harness in which: a tube-shaped space is formed by an exterior member, and a set of electrical wires is housed therein without being tied together; the set of electrical wires is prevented from protruding from an end edge of the exterior member on a winding start side even if the length of the exterior member by which the set of electrical wires is covered is large; and a wind overlapping portion of the exterior member on one end side is larger than that on the other end side so that a stably tied state of the electrical wires is satisfactorily ensured and the tying force on one end side is efficiently transmitted to the other end side.

### Solution to Problem

To achieve the above-described aim, a wire harness according to one aspect of the present invention includes: a set of electrical wires; and an exterior member that is wound around the set of electrical wires. The exterior member has been bent into a tube shape that allows the set of electrical wires to pass therethrough. An end edge of the exterior member on a winding start side is spirally wound around a circumferential surface of the set of electrical wires. A first end of the exterior member is wound a larger number of times than a second end of the exterior member.

In the wire harness according to this aspect of the present invention with this configuration, the exterior member has been bent into a tube shape that allows the set of electrical wires to pass therethrough. Therefore, a tube-shaped space is formed in the exterior member, and the set of electrical wires can be housed therein without being tied together. Also, the end edge of the exterior member on the winding start side is spirally wound around the circumferential surface of the set of electrical wires. Therefore, the set of electrical wires is prevented from protruding from the end edge of the exterior member on the winding start side even if the length of the exterior member by which the set of electrical wires is covered is large. Furthermore, the first end of the exterior member is wound a larger number of times than the second end of the exterior member, and the second end of the exterior member is wound at least once. Therefore, a wind overlapping portion of the exterior member on one end side is larger than that on the other end side so that a stably tied state of the electrical wires is ensured and the tying force on one end side is efficiently transmitted to the other end side.

In the wire harness according to this aspect of the present invention, it is preferable that an end edge of the exterior member on a winding end side is spirally wound around a circumferential surface of the set of electrical wires, and crosses the end edge of the exterior member on the winding start side that has a spiral shape.

The wire harness according to this aspect of the present invention with this configuration can more satisfactorily ensure the stably tied state of the electrical wires so that the tying force on the first end side is efficiently transmitted to the second end side.

In the wire harness according to this aspect of the present invention, it is preferable that, in laid-out view, the exterior member extends in a lengthwise direction of the set of electrical wires, and a width of the exterior member corresponding to a winding direction gradually decreases in the lengthwise direction from the first end to the second end. It is particularly preferable that the exterior member in laid-out view has a trapezoidal shape.

With this configuration, in the wire harness according to this aspect of the present invention, the first end side of the exterior member corresponds to the lower base of the trapezoid, and the second end side of the exterior member corresponds to the upper base of the trapezoid. The exterior member is manufactured by winding the exterior member having the trapezoidal shape around the set of electrical wires and tying the set of electrical wires together. If the trapezoidal shape of the exterior member is divided into an elongated rectangular shape defined by drawing perpendicular lines from the two ends of the upper base to the lower base, and right angle triangles defined on two sides of the elongated rectangle, one of the right angle triangles is wound first, then the elongated rectangle is wound, and finally the other right angle triangle is wound. Consequently, the exterior member allows the set of electrical wires to pass therethrough in a preferable manner.

It is preferable that the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

With the wire harness according to this aspect of the present invention having this configuration, it is unnecessary to open the end edge on the winding end side of the exterior member that has been bent into a tube shape, and to insert the set of electrical wires from the gap. Therefore, it is easy to assemble the wire harness, and the manufacturing cost is reduced.

### Advantageous Effects of Invention

According to one aspect of the present invention, it is possible to provide a wire harness in which: a tube-shaped space is formed by an exterior member, and a set of electrical wires is housed therein without being tied together; the set of electrical wires is prevented from protruding from an end edge of the exterior member on a winding start side even if the length of the exterior member by which the set of electrical wires is covered is large; and the wind overlapping portion of the exterior member on one end side is larger than that on the other end side so that a stably tied state of the electrical wires is satisfactorily ensured and the tying force on the one end side is efficiently transmitted to the other end side.

### BRIEF DESCRIPTION OF DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a front view of a wire harness according to an embodiment of the present invention in a routed state;

FIG. 2A is a cross-sectional view along a line A-A shown in FIG. 1, and

FIG. 2B is a cross-sectional view along a line B-B shown in FIG. 1;

FIGS. 3A and 3B constitute a process diagram showing a method for manufacturing a wire harness according to an embodiment of the present invention; and

FIG. 4 is a perspective view showing a wire harness according to a conventional example.

### DESCRIPTION OF EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice. The following describes a wire harness according to an embodiment of the present invention with reference to the drawings.

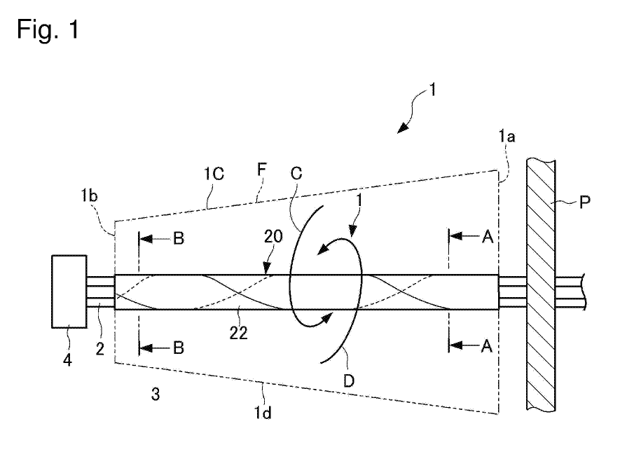

First, the configuration of the wire harness will be described. As shown in FIG. 1, a wire harness 1 includes: a set of electrical wires 2; and an exterior member 3 that is wound around the set of electrical wires 2 and that ties the set of electrical wires 2 together. According to this embodiment, a base end of the wire harness 1 is inserted through a through hole in a panel P of a vehicle or the like. The wire harness 1 is supported from below by a bracket provided on the panel P, for example, and is fixed to the bracket by an adhesive tape so as not to become separated therefrom. A connector 4 is connected to the projecting end of the set of electrical wires 2.

The set of electrical wires 2 is, for example, a bundle of: coated electrical wires that serve as data lines; coated electrical wires that serve as power supply lines; and bare electrical wires that serve as ground lines. In the present embodiment, the set of electrical wires 2 are not fixedly wound or roughly wound with an adhesive tape. The set of electrical wires 2 may be a strand of a plurality of coated electrical wires.

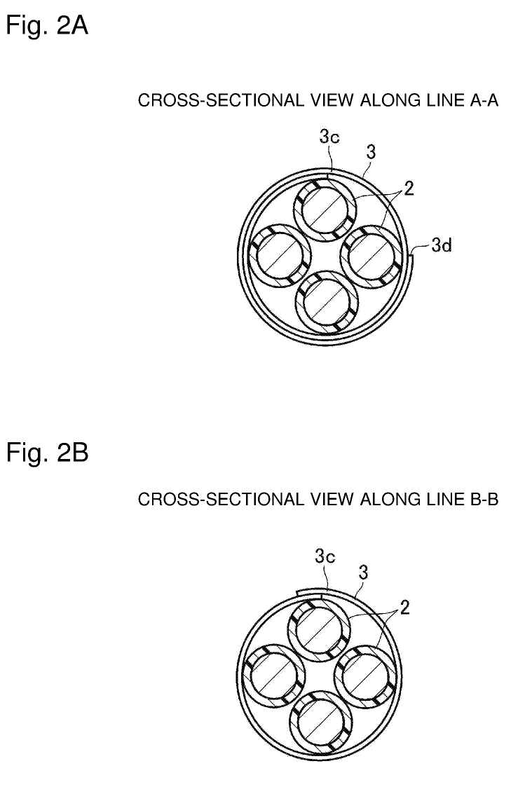

The exterior member 3 is made of shape-memory resin. A flat member F (indicated by a one-dot chain line in FIG. 1) that has memorized a tube shape that allows the set of electrical wires 2 to pass therethrough is prepared first. The exterior member 3 is formed by bending the flat member F into the tube shape, by the application of heat to the flat member F so as to restore the memorized tube shape. As shown in FIGS. 2A and 2B, the exterior member 3 allows the set of electrical wires 2 to pass therethrough in a fastened state, i.e., the exterior member 3 is wound around the set of electrical wires 2 in a tube shape so as to tie the set of electrical wires 2 together. Note that examples of shape-memory resin include shape-memory polyurethane polymers. There are two types of polyurethane, namely ether-based polyurethane and ester-based polyurethane, which differ in their composition of polyurethane macromolecule materials. The glass-transition temperature Tg is set to 80° C., for example.

In laid-out view, the exterior member 3 has a shape in which two end edges of the exterior member 3 in the direction that is orthogonal to the winding direction (an end edge 3c on the winding start side and an end edge 3d on the winding end side) are continuously inclined such that the exterior member 3 extends in the lengthwise direction of the set of electrical wires 2 and the width of the exterior member 3 corresponding to the winding direction gradually decreases in the lengthwise direction from a first end 3a (the base end) to a second end 3b (the projecting end). That is to say, the exterior member 3 has a trapezoidal shape whose heightwise direction coincides with the lengthwise direction of the set of electrical wires 2, and that narrows is elongated in the heightwise direction.

The exterior member 3 has been bent into a tube shape that allows the set of electrical wires 2 to pass therethrough. The end edge 3c on the winding start side is spirally wound around the circumferential surface of the set of electrical wires 2, and the end edge 3d on the winding end side is spirally wound around the circumferential surface of the set of electrical wires 2 and intersects the end edge 3c on the winding start side that has a spiral shape. The first end 3a side of the exterior member 3 is wound a larger number of times than the second end 3b side of the exterior member 3, and the second end 3b side is wound at least once.

If the trapezoidal shape of the exterior member 3 in laid-out view is divided into an elongated rectangular shape defined by drawing perpendicular lines from the two ends of the upper base to the lower base, and right angle triangles defined on two sides of the elongated rectangle, the hypotenuse of each right angle triangle when the exterior member 3 is wound around the set of electrical wires 2 forms a more gentle spiral as the length of the bottom side of the right angle triangle is increased, and consequently, the number of wound layers on one end side of the exterior member 3 in the lengthwise direction of the set of electrical wires 2 increases. The trapezoidal shape of the exterior member 3 in laid-out view is not necessarily an isosceles trapezoid shape.

The width of the exterior member 3 on the second end 3b side has a length that allows the exterior member 3 to be wound around the set of electrical wires 2 at least once, preferably once and a half for example, so that the set of electrical wires 2 is not exposed to the outside.

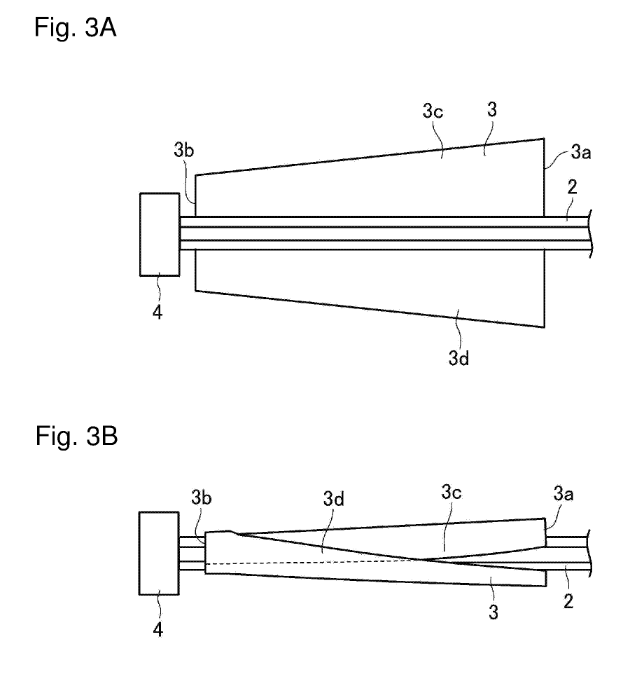

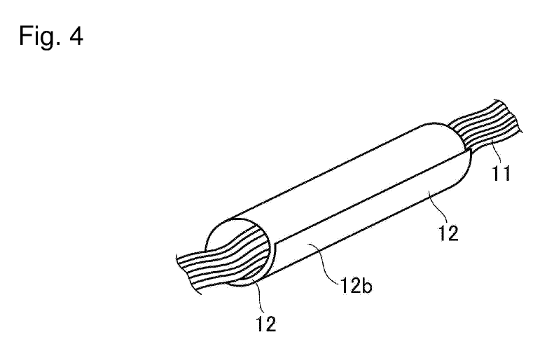

Next, a method for manufacturing the wire harness 1 is described with reference to FIGS. 3A and 3B.

First, as shown in FIG. 3A, the exterior member 3 is prepared. The exterior member 3 has memorized a tube shape that is to be restored and that allows the set of electrical wires 2 to pass therethrough. The exterior member 3 is enabled to memorize the shape by lowering the temperature of the exterior member 3 to 80° C. again so that the exterior member 3 returns to a soft state again, then removing a holding means to restore the initial flat trapezoidal shape of the exterior member 3, and finally lowering the temperature to room temperature. As a result, the exterior member 3 memorizes the shape when wound around a round rod.

Next, as shown in FIG. 3A, the set of electrical wires 2 that have not been tied together are placed on the exterior member 3.

Subsequently, hot air from a dryer is applied from below the exterior member 3, first to an area on the side of the end edge 3c on the winding start side, and then to an area on the side of the end edge 3d on the winding end side. As a result, as shown in FIG. 3B, the exterior member 3 is bent into a tube shape from the end edge 3c on the winding start side. The exterior member 3 is restored to the memorized tube shape such that the end edge 3d on the winding end side overlaps the outer side of the end edge 3c on the winding start side, and such that the exterior member 3 allows the set of electrical wires 2 to pass therethrough in a fastened state and ties the set of electrical wires 2 together.

The following describes the process of restoring the memorized tube shape of the exterior member 3 by heating the exterior member 3 through the application of hot air from the dryer. The first end 3a side of the exterior member 3 corresponds to the lower base of the trapezoid, and the second end 3b side of the exterior member 3 corresponds to the upper base of the trapezoid. The exterior member 3 is manufactured by winding the exterior member 3 having the trapezoidal shape around the set of electrical wires 2 and tying the set of electrical wires 2 together. If the trapezoidal shape of the exterior member 3 is divided into an elongated rectangular shape defined by drawing perpendicular lines from the two ends of the upper base to the lower base, and right angle triangles defined on two sides of the elongated rectangle, first, one of the right angle triangles is wound first, then the elongated rectangle is wound, and finally the other right angle triangle is wound.

In the wire harness 1, the number of wound layers on the first end 3a side of the exterior member 3 is larger than the number of wound layers on the second end 3b side. As indicated by an arrow C in FIG. 1, first, the bottom side of one of the right angle triangles is wound around the set of electrical wires 2 while being reliably fixed to the set of electrical wires 2 on the first end 3a side, and thus the hypotenuse of the right angle triangle is wound around the set of electrical wires 2 such that a spiral line extends toward the second end 3b side without loosening. Next, the elongated rectangle is wound around the set of electrical wires 2 across the entire length of the set of electrical wires 2. Subsequently, as indicated by an arrow D shown in FIG. 1, when the other right angle triangle is wound around the set of electrical wires 2, the hypotenuse of the right angle triangle is wound around the set of electrical wires 2 such that a spiral line extends toward the first end 3a side without loosening. Thus, as shown in FIG. 1, the exterior member 3 allows the set of electrical wires 2 to pass therethrough in a fastened state and ties the set of electrical wires 2 together.

Therefore, in the wire harness 1, the exterior member 3 can be wound around the set of electrical wires 2 in a cylindrical shape such that the end edge 3c on the winding start side and the end edge 3d on the winding end side are spirally wound around the circumferential surface of the set of electrical wires 2 and intersect each other. Since the end edge 3c on the winding start side is spirally wound around the circumferential surface of the set of electrical wires 2, even if the length of the exterior member 3 coating the set of electrical wires 2 is large, there is no possibility at all of a largo gap being formed in the lengthwise direction of the set of electrical wires 2 between the end edge 3c on the winding start side and a portion of the exterior member 3 that overlaps the end edge 3c on the winding start side. Therefore, when the set of electrical wires 2 is housed in the tube-shaped exterior member 3 without being tied together: the set of electrical wires 2 is prevented from protruding from the end edge 3c on the winding start side of the exterior member 3; the wind overlapping portion of the exterior member 3 on one end side is larger than that on the second end 3b side so that a stably tied state of the set of electrical wires 2 is satisfactorily ensured; and the tying force on the first end 3a side is efficiently transmitted to the second end 3b side. The wire harness 1 provides the set of electrical wires 2 with a range of movement required for positional changes of the set of electrical wires 2 on the second end 3b side when being bent. That is to say, the wire harness 1 can be installed and used in the state where one end of the exterior member 3 is fixed and the other end serves as a free end, and the set of electrical wires 2 can be displaced by a certain amount.

The wire harness according to one aspect of the present invention may be configured with an exterior member formed by bending a woven cloth of non-shape-memory resin such as polyester resin into a tube shape so that the exterior member having a tube shape can be opened to allow the set of electrical wires to pass therethrough in a fastened state.

According to one aspect of the present invention, there are advantages that: a tube-shaped space is formed by an exterior member, and a set of electrical wires is housed in the exterior member without being tied together; the set of electrical wires is prevented from protruding from an end edge of the exterior member on a winding start side even if the length of the exterior member by which the set of electrical wires is covered is large; and the wind overlapping portion of the exterior member on the first end side is larger than that on the second end side so that a stably tied state of the electrical wires is satisfactorily ensured and the tying force on the first end side is efficiently transmitted to the second end side. The present invention is applicable to general wire harnesses in which an exterior member is wound around a set of electrical wires in a cylindrical shape.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

1. A wire harness comprising:
a set of electrical wires; and
an exterior member that is wound around the set of electrical wires,
wherein the exterior member has been bent into a tube shape that allows the set of electrical wires to pass therethrough, an end edge of the exterior member on a winding start side is spirally wound around a circumferential surface of the set of electrical wires, and a first end of the exterior member is wound a larger number of times than a second end of the exterior member.

2. The wire harness according to claim 1,
wherein an end edge of the exterior member on a winding end side is spirally wound around a circumferential surface of the set of electrical wires, and intersects the end edge of the exterior member on the winding start side that has a spiral shape.

3. The wire harness according to claim 1,
wherein in laid-out view, the exterior member extends in a lengthwise direction of the set of electrical wires, and a width of the exterior member corresponding to a winding direction gradually decreases in the lengthwise direction from the first end to the second end.

4. The wire harness according to claim 2,
wherein in laid-out view, the exterior member extends in a lengthwise direction of the set of electrical wires, and a width of the exterior member corresponding to a winding direction gradually decreases in the lengthwise direction from the first end to the second end.

5. The wire harness according to claim 3,
wherein the exterior member in laid-out view has a trapezoidal shape.

6. The wire harness according to claim 4,
wherein the exterior member in laid-out view has a trapezoidal shape.

7. The wire harness according to any one of claim 1,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

8. The wire harness according to any one of claim 2,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

9. The wire harness according to any one of claim 3,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

10. The wire harness according to any one of claim 4,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

11. The wire harness according to any one of claim 5,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.

12. The wire harness according to any one of claim 6,
wherein the exterior member is made of shape-memory resin, and is formed by bending a flat member into a tube shape that has been memorized by the flat member, through the application of heat to the flat member so as to restore the tube shape, the tube shape allowing the set of electrical wires to pass therethrough.
